(19) United States
(12) Patent Application Publication
(10) Pub. No.: US 2002/0131610 A1
(43) Pub. Date: Sep. 19, 2002

(54) Device for sound-based generation of abstract images

(76) Inventors: Augusto Grillo, Santo Stefano Ticino (IT); Stefano Breccia, Picenze Di Bresciano (IT)

Correspondence Address: CONLEY ROSE & TAYON, P.C., P. O. BOX 3267, HOUSTON, TX, 77253-3267, US

(21) Appl. No.: 09/957,828

(22) Filed: Sep. 21, 2001

(30) Foreign Application Priority Data
Sep. 21, 2000 (IT) MI2000A 002061

(51) Int. Cl. H04B 1/00

(52) U.S. Cl. 381/119

(57) ABSTRACT

A device for sound-based generation of abstract images, having at least one input connected to a signal source to receive a first electric signal representing a sound event; and at least one output connected to a display device. The device also includes an interconversion device connected to the input, to receive the first electric signal, and to the output, and supplying at the output a second electric signal correlated to the first electric signal and representing an image displayable on the display device.

### CROSS-REFERENCE TO RELATED APPLICATIONS

This application claims priority of Italian Application No. MI2000A 002061 filed Sep. 21, 2000 hereby incorporated herein by reference.

### STATEMENT REGARDING FEDERALLY SPONSORED RESEARCH OR DEVELOPMENT

Not Applicable.

The present invention relates to a device for sound-based generation of abstract images.

### BACKGROUND OF THE INVENTION

Devices are known which provide for correlating optical and sound events. For example, in some devices for dance-halls, an input signal representing a sound event (e.g. reproduced music) is processed and used to alternately turn a number of different-colored lamps on and off. The number of lamps turned on may be determined, for example, by the amplitude of the input signal; or the input signal may be filtered to generate a number of filtered signals corresponding to respective spectral components and related to a respective lamp, which is turned on and off alternately, depending on whether the filtered signal is above or below a predetermined threshold.

Known devices, however, only provide for a small range of simple, narrowly differing effects, and no satisfactory solution has yet been proposed to the problem of deterministic, sound-based generation of complex images.

### SUMMARY OF THE INVENTION

It is an object of the present invention to provide a sound-based image generating device designed to solve the aforementioned problem.

According to the present invention, there is provided a device for sound-based generation of abstract images, comprising at least one input connected to a signal source to receive a first electric signal representing a sound event; and at least one output connected to display means; characterized by comprising interconversion means connected to said input, to receive said first electric signal, and to said output, and supplying at said output a second electric signal correlated to said first electric signal and representing an image displayable on said display means.

### BRIEF DESCRIPTION OF THE DRAWINGS

A number of non-limiting embodiments of the invention will be described by way of example with reference to the accompanying drawings, in which:

FIGS. 1 to 3 show, schematically, respective service configurations of an interconversion device in accordance with the present invention;

FIG. 4 shows a block diagram of an interconversion device in accordance with the present invention;

FIG. 5 shows a more detailed block diagram of a detail of the FIG. 4 device;

FIG. 6 shows a flow chart of the present invention.

### DETAILED DESCRIPTION OF THE INVENTION

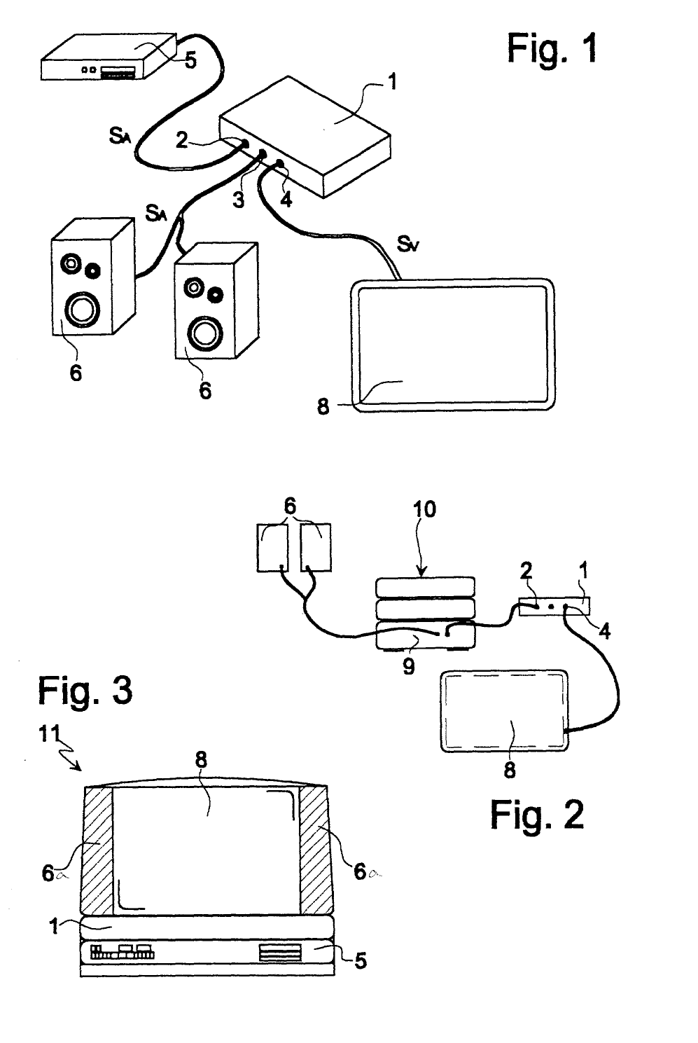

With reference to FIG. 1, an interconversion device 1 in accordance with the invention comprises an audio input 2, an audio output 3, and a video output 4.

Audio input 2 is connected to an audio source 5, which supplies an electric audio signal S_{A} representing a sound event, such as a piece of music or sounds characteristic of a particular natural environment. In particular, audio source 5 may be defined by a reproduction device, such as a tape recorder or compact disc, or by a microphone; and audio signal S_{A} is obtained in known manner by transducing and coding sound events.

Audio output 3 is connected to a speaker system 6 for reproducing and diffusing in the surrounding environment the sound events coded by audio signal S_{A}.

Video output 4 is connected to a display device 8 (e.g. a television or electronic computer screen or a projector) and supplies an electric video signal S_{V} correlated to audio signal SA and representing an image displayable on display device 8. Video signal S_{V} is a standard, preferably PAL, NTSC, SECAM, Standard VGA or Standard Super VGA, signal.

Alternatively, interconversion device 1 may be connected by audio input 2 to an amplifier 9 of a high-fidelity system 10, as shown in FIG. 2; or may form part of an integrated system 11 (FIG. 3), in which case, display device 8 is preferably a plasma or liquid-crystal screen bordered by linear loudspeakers 6a to permit sound reproduction and image display by a single item. Interconversion device 1 may also comprise known parts of an electronic computer (e.g. a microprocessor, memory banks) and program code portions.

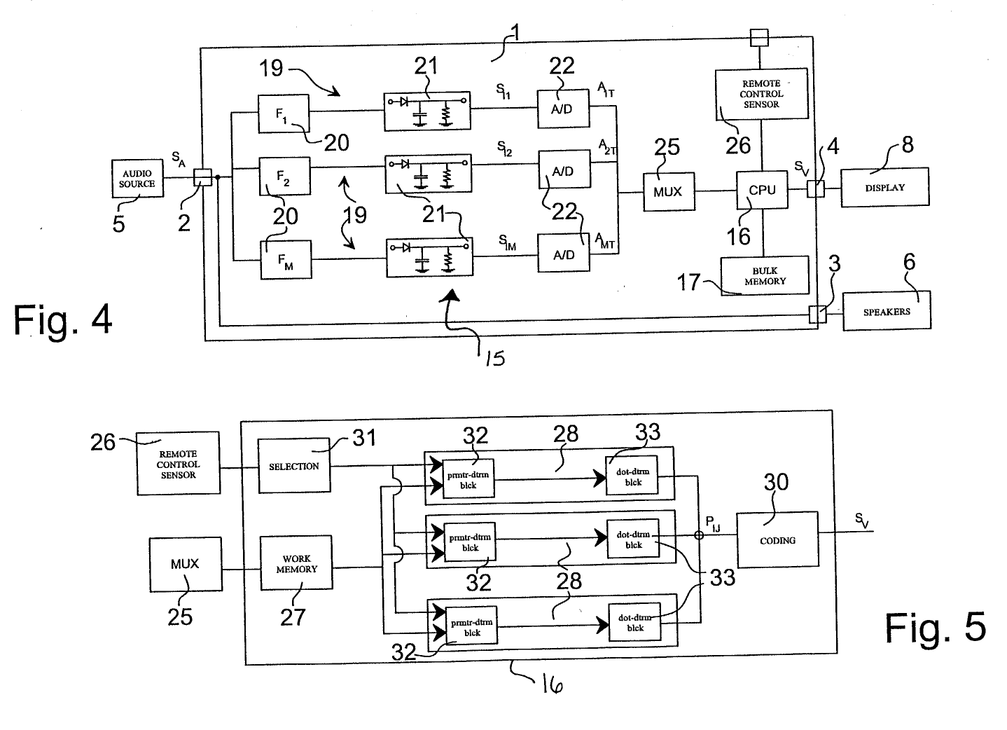

With reference to FIG. 4, interconversion device 1 comprises a preprocessing stage 15, a processing unit 16, and a bulk memory 17, preferably a hard disk of the type normally used in electronic computers; and audio input 2 and audio output 3 are connected directly to transmit audio signal S_{A} to speaker system 6.

Preprocessing stage 15 comprises a number of acquisition channels 19, e.g. eight or sixteen, each in turn comprising a filter 20, an equalizing circuit 21, and an analog-digital converter 22, cascade-connected in that order.

More specifically, filters 20 are preferably selective band-pass analog filters having respective distinct mid-frequencies F₁, F₂, . . . , F_{M}, where M is the number of acquisition channels 19, and having respective inputs connected to audio input 2.

In the preferred embodiment described, equalizing circuits 21 include peak detecting circuits, and supply respective envelope signals S_{I1}, S_{I2}, . . . , S_{IM} correlated to the amplitudes of spectral components of audio signal S_{A} corresponding to mid-frequencies F₁, F₂, . . . , F_{M} respectively.

Analog-digital converters 22 receive respective envelope signals S_{I1}, S_{I2}, . . . , S_{IM}, and supply respective sampled amplitude values A_{1T}, A_{2T}, . . . , A_{MT} (T indicating a generic sampling period) at respective outputs connected to a multiplexer 25. 201 In other words, each acquisition channel 19 has a respective associated mid-frequency F₁, F₂, . . . , F_{M}, and supplies a respective sampled amplitude value A_{1T}, A_{2T}, . . . , A_{MT}.

Multiplexer 25 is in turn connected to and supplies processing unit 16 with the amplitude values A_{1T}, A_{2T}, . . . , A_{MT} at its inputs.

Processing unit 16 is also connected to bulk memory 17; to video output 4, to which it supplies video signal S_{V}; and to a remote control sensor 26, which receives a number of control signals from a known remote control device (not shown) to permit user interaction with processing unit 16.

As shown in detail in FIG. 5, processing unit 16 comprises a work memory 27 connected to multiplexer 25; a number of computing lines 28; and a coding block 30. And a selection block 31, connected to remote control sensor 26, supplies an enabling signal to selectively activate one of computing lines 28 and exclude the others.

Computing lines 28 between work memory 27 and coding block 30 comprise respective parameter-determining blocks 32 cascade-connected to respective dot-determining blocks 33. More specifically, when respective computing lines 28 are activated, parameter-determining blocks 32 receive amplitude values A_{1T}, A_{2T}, . . . , A_{MT} and accordingly determine respective operating parameter sets PS₁, PS₂, . . . , PS_{N} (where N equals the number of computing lines 28 provided). More specifically, each operating parameter set PS₁, PS₂, . . . , PS_{N} comprises at least M operating parameters, each correlated to at least one respective sampled amplitude value A_{1T}, A_{2T}, . . . , A_{MT}.

Dot-determining blocks 33 receive respective operating parameter sets PS₁, PS₂, . . . , PS_{N}, and, according to respective distinct image-generating functions, generate respective matrixes of image dots P_{IJ}, each of which is defined at least by a respective position and by a respective shade selected from a predetermined shade range. More specifically, the shade is determined in known manner by combining respective levels of three primary colors.

The matrix of image dots P_{IJ} representing an image for display is supplied to coding block 30, which codes the values in the matrix using a standard coding system (PAL, NTSC, SECAM, Standard VGA, Standard Super VGA) to generate video signal S_{V}, which is supplied to video output 4 of interconversion device 1, to which coding block 30 is connected.

By means of respective user commands on the remote control device, the image on display device 8 can be stilled (to temporarily “freeze” the currently displayed image) and an image stored in bulk memory 17. Alternatively, a previously memorized image can be recalled from bulk memory 17 and displayed on the screen, regardless of the form of audio signal S_{A}.

The image-generating functions are preferably determined from families of fractal set-generating functions, and are defined, in each dot-determining block 33, by means of respective operating parameter set PS₁, PS₂, . . . , PS_{N}. More specifically, dot-determining blocks 33 employ respective distinct families of fractal sets generating functions (e.g. well known families of Mandelbrot sets, Julia sets and Lorenz sets generating functions). In each sampling period T, parameter-determining block 32 of the active computing line 28 generates a respective operating parameter set PS₁, PS₂, . . . , PS_{N}, which is used by the respective active dot-determining block 33 to select M image-generating functions from the family of fractal set-generating functions used by dot-determining block 33. In other words, each function is defined by one or more respective operating parameters in the operating parameter set PS₁, PS₂, . . . , PS_{N} generated in sampling period T on the active computing line 28, so that each selected image-generating function is correlated at least to a respective sampled amplitude value A_{1T}, A_{2T}, . . . , A_{MT} and therefore to a respective spectral component of audio signal S_{V}.

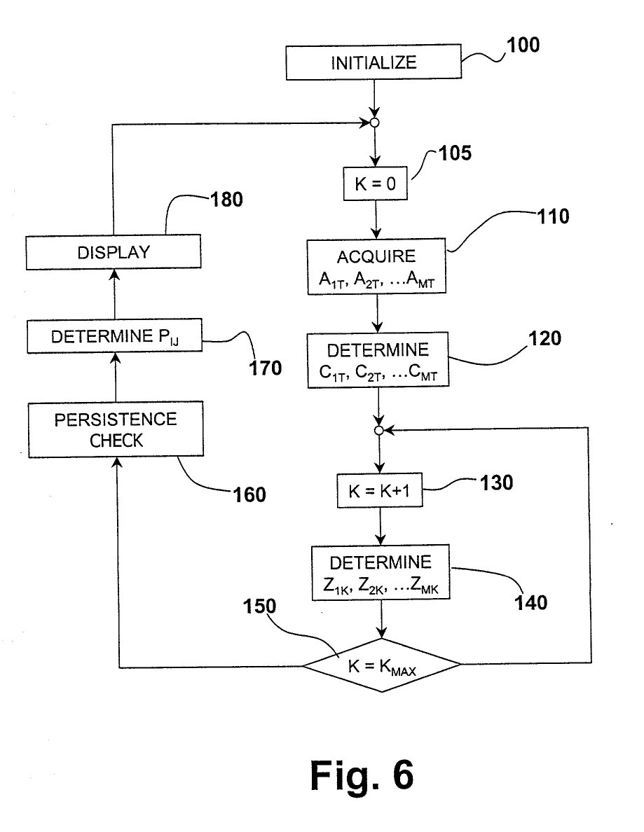

The matrix of image dots P_{IJ} is determined from the selected image-generating functions, by means of an iterative process having a predetermined number of iteration steps, as shown in the FIG. 6 example below.

In other words, audio signal S_{A} supplied by audio source 5 to interconversion device 1 is first broken down into the spectral components corresponding respectively to mid-frequencies F₁, F₂, . . . , F_{M} of filters 20; the amplitudes of the spectral components are then determined and sampled by means of equalizing circuits 21 and analog-digital converters 22 to obtain sampled amplitude values A_{1T}, A_{2T}, . . . , A_{MT} corresponding respectively to mid-frequencies F₁, F₂, . . . , F_{M}; and the sampled amplitude values A_{1T}, A_{2T}, . . . , A_{MT} are then memorized temporarily in work memory 27. One of computing lines 28, selected beforehand by the user by means of a remote control device (acting in known manner on remote control sensor 26 and on selection block 31), is active and receives sampled amplitude values A_{1T}, A_{2T}, . . . , A_{MT}; parameter-determining block 32 of the active computing line 28 determines the operating parameters to be supplied to respective dot-determining block 33 to select M image-generating functions from the respective fractal set-generating family; and dot-determining block 33 of the active computing line 28 then uses the M selected image-generating functions to compute the matrix of image dots P_{IJ}.

Each selected image-generating function is therefore correlated to a respective sampled amplitude value A_{1T}, A_{2T}, . . . , A_{MT}, and therefore to a respective spectral component of audio signal S_{A} in sampling period T.

The matrix of image dots P_{IJ} generated by the image-generating functions and representing an image for display is therefore also determined by the form of audio signal S_{A} (in particular by the amplitude, in sampling period T, of the spectral components corresponding to mid-frequencies F₁, F₂, . . . , F_{M} of filters 20); and audio signal S_{A} is in turn correlated to a sound event, from which it is generated, by means of a known transducing and coding process, so that the images displayed each time on screen 8 are correlated, according to predetermined repetitive algorithms, to the sound events represented by audio signal S_{A}.

An image-generating and -display process will now be described in more detail and by way of example with reference to FIG. 6. More specifically, the FIG. 6 block diagram relates to a computing line 28 on which the respective dot-determining block 33 employs a family of Mandelbrot set-generating functions, which, as is known, is defined by the equations:

Z_{K}=Z_{K-1}²+C (1a)

Z_{O}=0 (1b)

where Z is a complex variable; C is a constant complex coefficient; an K is a generic iteration step. More specifically, in each sampling period T, M image-generating functions are selected, each defined by a respective value C₁, C₂, . . . , C_{M} of coefficient C; which values therefore represent the operating parameters by which to select the image-generating functions from the Mandelbrot set-generating function. Moreover, each image dot P_{IJ} to be displayed is related to a respective complex number: Cartesian coordinates of image dots P_{IJ} are given by the real parts and imaginary parts respectively of the related complex numbers.

When a computing line 28 is activated, an initializing step is performed (block 100) in which an origin of a plane containing image dots P_{IJ} is defined, and coefficients C₁, C₂, . . . , C_{M} are set to respective start values (e.g. zero); and iteration step K is set to zero (block 105).

Sampled amplitude values A_{1T}, A_{2T}, . . . , A_{MT} (block 110) are then acquired, memorized in work memory 27 and supplied to the active parameter-determining block 32, which determines current coefficient values C₁, C₂, . . . , C_{M} (block 120), e.g. by means of equations:

$$\{ \begin{matrix}{C}_{1 T} = {A}_{1 T} + \underline{i} {A}_{1 T - 1} \\ {C}_{2 T} = {A}_{2 T} + \underline{i} {A}_{2 T - 1} \\ … \\ {C}_{MT} = {A}_{MT} + \underline{i} {A}_{MT - 1}\end{matrix} \qquad ( 2 )$$

where T−1 is a sampling period immediately preceding sampling period T; and i is the imaginary unit.

Iteration step K is then incremented (block 130), and dot-determining block 33 (block 140) determines a step K set of image dots Z_{1K}, Z_{2K}, . . . , Z_{MK} on the basis of equations (1a), (1b) and the values of coefficients C₁, C₂, . . . , C_{M} resulting from equations (2). In other words, the following image-generating functions are used:

$$\begin{matrix}\{ \begin{matrix}{Z}_{1 K} = {Z}_{1 K - 1}^{2} + {C}_{1} \\ {Z}_{2 K} = {Z}_{2 K - 1}^{2} + {C}_{2} \\ … \\ {Z}_{MK} = {Z}_{MK - 1}^{2} + {C}_{M}\end{matrix} & \text{(3a)} \\ \{ \begin{matrix}{Z}_{10} = 0 \\ {Z}_{20} = 0 \\ … \\ {Z}_{M0} = 0\end{matrix} & \text{(3b)}\end{matrix}$$

The determined step K image dots Z_{1K}, Z_{2K}, . . . , Z_{MK} are then assigned a respective shade (block 150). For example, all the step K image dots Z_{1K}, Z_{2K}, . . . , Z_{MK} are assigned the same shade on the basis of the value of iteration step K.

A test (block 150) is then conducted to determine whether iteration step K is less than a predetermined maximum number of iterations K_{MAX} (e.g. 500). If it is, the iteration step is incremented again, and a new set of step K image dots is determined (blocks 130, 140). If it is not, a persistence check (block 160) is performed to select, on the basis of a predetermined persistence criterion, previously displayed image dots (i.e. up to sampling period T−1) to be displayed again. According to a first persistence criterion, only a predetermined number of last-displayed previous image dots are displayed again, the others being eliminated. Alternatively, persistence time may depend, for example, on the shade of each image dot, or be zero (in which case, no dot in the previous images is displayed again).

The matrix of image dots P_{IJ} representing the image to be displayed in sampling period T (block 170) is then determined, and is defined by all the step K image dots Z_{1K}, Z_{2K}, . . . , Z_{MK} (K=0, 1, . . . , K_{MAX}) determined in sampling period T, and by the image dots selected from images displayed up to sampling period T−1.

Finally, the matrix of image dots P_{IJ} is supplied to coding block 30 for display (block 180), the iteration step is zeroed and a new set of sampled amplitude values A_{1T}, A_{2T}, . . . , A_{MT} is acquired (blocks 105, 110).

The following are further examples of image-generating processes and functions for generating and displaying images.

### EXAMPLE 1

The image-generating functions are obtained from equations (3a), (3b) and equations:

$$\begin{matrix}{Re N}_{A} = \frac{cos α}{2} - \frac{cos 2 α}{4} & \text{(4a)} \\ {Im N}_{A} = \frac{sin α}{2} - \frac{sin 2 α}{4} & \text{(4b)}\end{matrix}$$

where α is a real number from 0 to 2π; and N_{A} is an auxiliary complex number.

The algorithm comprises the following steps. In each sampling period T, the value of α is incremented by a predetermined value (e.g. 0.3 of a radian), and auxiliary number N_{A} is calculated. For each sampled amplitude value A_{1T}, A_{2T}, . . . , A_{MT}, a value of a respective variable P_{1T}, P_{2T}, P_{MT} is calculated; which values preferably range from 0.95 to 1.05, and, in particular, are 0.95 when respective sampled amplitude values A_{1T}, A_{2T}, . . . , A_{MT} are zero, and 1.05 when respective sampled amplitude values A_{1T}, A_{2T}, . . . , A_{MT} are maximum. Coefficients C₁, C₂, . . . , C_{M} of equations (3a) are set respectively to P_{1T}^{N}_{A}, P_{2T}^{N}_{A}, . . . , P_{MT}^{N}_{A}. A predetermined number of image dots are then calculated using equations (2a), (2b) iteratively. The color and brightness of the dots are preferably selected on the basis of mid-frequencies F₁, F₂, . . . , F_{M} and sampled amplitude values A_{1T}, A_{2T},..., A_{MT} respectively.

### EXAMPLE 2

An approximate algorithm is used to generate Julia sets, in particular the one described in “The Science of Fractal Images”, Peitgen, Saupe, p. 152 onwards. More specifically, the following equations are used:

$$\{ \begin{matrix}{Z}_{1 K - 1} = \sqrt{{Z}_{1 K} - {C}_{1}} \\ {Z}_{2 K - 1} = \sqrt{{Z}_{2 K} - {C}_{2}} \\ … \\ {Z}_{MK - 1} = \sqrt{{Z}_{MK} - {C}_{M}}\end{matrix} \qquad ( 5 )$$

which are obviously obtained from equations (3a); and coefficients C₁, C₂, . . . , C_{M} are calculated by means of equations (2), as shown with reference to FIG. 6.

In other words, a set of initializing dots Z_{1S}, Z_{2S}, . . . , Z_{MS} is defined, and the so-called regressive orbit of which is determined by means of equations (5).

The above (complex variable quadratic) equations are resolved using polar coordinate representation, whereby a complex number having a real part X and an imaginary part Y can be expressed by a radius vector R and an anomaly (p by means of equations:

X=R.cosφ

Y=R.sinφ (6)

In this representation, the square roots of a complex number having radius vector R and anomaly φ are two numbers having a radius vector equal to the square root of radius vector R and an anomaly equal to φ/2 and φ/2+n respectively. And, since Julia sets are self-similar, one of the calculated square roots can be discarded at each iteration step.

### EXAMPLE 3

In this case, the Lorenz nonlinear differential system is used:

\dot{X}(τ)=A(Y(τ)−X(τ))

\dot{Y}(τ)=BX(τ)−Y(τ)−X(τ)Z(τ) (7)

\dot{Z}(τ)=−CZ(τ)+X(τ)Y(τ)

where X, Y, Z are unknown functions; A, B, C are constant coefficients; and τ is a current parameter.

More specifically, a system (7) is used for each acquisition channel 19, and sampled amplitude values A_{1T}, A_{2T}, . . . , A_{MT} are used to determine constants B or respective systems (7).

Systems (7) are then resolved (e.g. using the algorithm described in “Dynamic Systems and Fractals”, Becker, Dörfier, p. 64 onwards) to determine respective functions X(τ), Y(τ), Z(τ) for each.

Each set of three functions X(τ), Y(τ), Z(τ) may obviously be used to define the trajectory of a virtual point in three-dimensional space. The value of current parameter τ is incremented, and the position of a new virtual point is determined for each acquisition channel 19. The virtual points are then projected onto an image plane to define a set of image dots, each related to a respective channel. For each channel, a predetermined number of more recent image dots are memorized; in each sampling period T, the longest-memorized image dots are deleted; and the brightness level of the others is reduced so that brightness is maximum for the more recent image dots.

### EXAMPLE 4

In this case, N poles (each related to a respective acquisition channel 19) equally spaced along a circumference of predetermined radius are first defined in an image plane. In each sampling period T, a circle is displayed close to each pole, the color and diameter of which are correlated to the pole-related acquisition channel 19, and the brightness of which is correlated to a respective sampled amplitude value A_{1T}, A_{2T}, . . . , A_{MT}. In successive sampling periods T, the center and a point along the circumference of each circle are subjected to an affine contraction transformation to define a further set of circles. The contraction transformation is defined by the matrix equation:

$$[ \begin{matrix}{X}_{N} \\ {Y}_{N}\end{matrix} ] = [ \begin{matrix}{X}_{0} \\ {Y}_{0}\end{matrix} ] \cdot [ \begin{matrix}A & B \\ C & D\end{matrix} ] + [ \begin{matrix}E \\ F\end{matrix} ] \qquad ( 8 )$$

where X_{O}, Y_{O} and X_{O}, Y_{N} are the coordinates of a generic point before and after transformation respectively; and A, B, C, D, E, F are predetermined constant coefficients. The following condition is also imposed:

$$det [ \begin{matrix}A & B \\ C & D\end{matrix} ] < 1 \qquad ( 9 )$$

The result is a succession of smaller and smaller diameter circles in a contracting spiral about each respective pole.

### EXAMPLE 5

In this case, in each sampling period T, a number of circles are displayed equal to the number of sampled amplitude values A_{1T}, A_{2T}, ., A_{MT} acquired (and therefore to the number of acquisition channels 19). The coordinates of the center of each circle are generated by means of a known random number-generating algorithm; color is preferably selected according to the mid-frequencies F₁, F₂, . . . , F_{M} related to respective acquisition channels 19; the radius and brightness of each circle are proportional to a respective sampled amplitude value A_{1T}, A_{2T}, . . . , A_{MT}; and the radius and brightness of a circle displayed in sampling period T are decreased in successive sampling periods until the circle eventually disappears.

The device described advantageously provides for generating, from sounds represented by an audio electric signal, complex images varying continually according to the form of the signal. That is, by means of the interconversion device according to the invention, each sound sequence can be related to a respective image sequence. And, given the ergodic property typical of fractal phenomena, even different renderings of the same piece of music may produce widely differing image sequences. Moreover, the interconversion device provides for generating the image sequences as the sounds are being reproduced and broadcast, thus enabling the user to assign correlated visual and auditory sensations.

Clearly, changes may be made to the device as described herein without, however, departing from the scope of the present invention. In particular, image-generating processes and functions other than those described may obviously be used.

Moreover, audio signal S_{A} may be filtered using numeric filters implemented by control unit 16; in which case, the analog-digital converters are located upstream from the filters, and the equalizing circuits may be replaced, for example, by blocks for calculating the fast Fourier transform (FFT) of audio signal S_{A} in known manner. Though a control unit with much higher computing power is required, this solution has the added advantage of simplifying the circuitry by requiring fewer components.

1. A device for sound-based generation of abstract images, comprising:
at least one input connected to a signal source to receive a first electric signal representing a sound event; and
at least one output connected to display means, characterized by comprising interconversion means connected to said input to receive said first electric signal and to said output, and supplying at said output a second electric signal correlated to said first electric signal and representing an image displayable on said display means.

2. The device as claimed in claim 1, characterized in that said interconversion means comprises:
a preprocessing means for determining a number of first quantities correlated to said first electric signal; and
a numeric processing means for determining, from said first quantities, a number of second quantities defining a respective said image.

3. The device as claimed in claim 2, characterized in that said numeric processing means comprises a number of computing means, selectively activated to determine said second quantities on the base of respective generating functions.

4. The device as claimed in claim 2, characterized in that said numeric processing means comprises coding means connected to said computing means and supplying said second electric signal.

5. The device as claimed in claim 2, characterized in that said numeric processing means comprises:
a work memory means for acquiring and memorizing successive values of said first quantities;
a parameter-determining means connected to respective dot-determining means and supplying respective sets of operating parameters correlated to at least some of said successive values of said first quantities; and
a selection means for selecting one of said computing means.

6. The device as claimed in claim 2, characterized in that said preprocessing means comprises a number of filtering means receiving said first electric signal and having respective distinct mid filtering frequencies.

7. The device as claimed in claim 6, characterized in that said filtering means comprises respective analog filters, and in that said preprocessing means comprises analog-digital converting means downstream from said analog filters.

8. The device as claimed in claim 2, characterized by comprising bulk memory means connected to said numeric processing means to memorize sets of said second quantities.

9. A method for sound-based generation of abstract images, comprising:
providing a first electric signal correlated to a sound event and display means; and
generating a second electric signal correlated to the first electric signal and representing an image displayable on the display means.

10. The method as claimed in claim 9, characterized in that the step of generating the second electric signal comprises:
preprocessing the first electric signal to determine a number of first quantities correlated to the first electric signal; and
numerically processing the first quantities to determine a number of second quantities defining a respective image.

11. The method as claimed in claim 10, characterized in that the step of numerically processing the first quantities comprises:
selecting a generating function for generating the second quantities;
determining a set of operating parameters of the generating function, correlated to the first quantities; and
determining the second quantities on the basis of the generating function and the operating parameters.

12. The method as claimed in claim 11, characterized in that the generating function is a fractal set-generating function.
